(19) United States
(12) Patent Application Publication
(10) Pub. No.: US 2005/0222900 A1
(43) Pub. Date: Oct. 6, 2005

(54) Selectively delivering advertisements based at least in part on trademark issues

(76) Inventors: Prashant Fuloria, Mountain View, CA (US); Rose Hagan, Berkeley, CA (US); Salar Arta Kamangar, Palo Alto, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/812,394

(22) Filed: Mar. 30, 2004

(51) Int. Cl. G06F 17/60

(52) U.S. Cl. 705/14

(57) ABSTRACT

A system and method for selectively delivering legal information communications for documents (e.g., advertisements). An input is received, wherein the input is a document delivery-triggering event operative to cause a document to be delivered to a user. A location associated with the input is identified. Based at least in part on the location, it is determined whether to provide a legal information communication. A document is delivered based at least in part on the input, wherein the document is delivered with a legal information communication if the location is determined to be in a legal information communication jurisdiction.

### FIELD OF THE INVENTION

The present inventions relate generally to selectively providing advertisements based in part on trademark issues associated with the advertisement and one or more content-based concepts.

### BACKGROUND OF THE INVENTION

With the advent of the Internet, advertising over more interactive media has become popular. Merchants and their advertising agents (individually and collectively, “advertisers”) have developed several strategies in an attempt to maximize the value of such advertising. For example, advertisers may place advertisements on home pages of various web sites (e.g., news web sites, search engines, etc.). Advertisers try to target advertisements to a more narrow audience in order to increase the likelihood of a positive response by the audience. For example, a hotel in Las Vegas may promote special discounts on a travel website, specifically on the web pages directed to Las Vegas vacations.

Advertisers can also reach targeted audiences through targeted ads provided at a search site provider on the basis of a user's search or input query. The ads typically include a link to the advertiser's website where the user can purchase the advertised product or service.

In one example, advertisements are associated with one or more keywords or other concepts, typically on the basis of related subject matter. For instance, a company that sells books such as cookbooks might request an association of an ad for a cookbook with the keyword “recipe.” When a user inputs one or more keywords (or related terms) as in an input query, the advertising system may select targeted ads associated with the keywords (or related terms) and displays the ads along with the search results. For instance, when a user enters the search query “lasagna recipe,” the search engine may select the cookbook ad and display it to the user. Various trademark issues may be raised if the terms input by the user are subject to trademark rights.

These and other drawbacks exist with current systems and methods.

### SUMMARY OF THE INVENTION

Accordingly, in one exemplary embodiment, a system and method for selectively delivering disclaimers for documents (e.g., advertisements) is provided. An input is received, wherein the input is a document delivery-triggering event operative to cause a document to be delivered to a user. A location associated with the input is identified. Based at least in part on the location, it is determined whether to provide a legal information communication. A document is delivered based at least in part on at least in part on the input, wherein the document is delivered with a legal information communication if the location is determined to be in a legal information communication jurisdiction.

In another exemplary embodiment, a method of selectively delivering documents responsive to received information includes actions to receive a request related to a concept from a requesting system, identify one or more documents for possible delivery in response to the request based no the concept and determine whether to deliver the one or more documents based at least in part on one or more trademark factors and an acceptance level for trademark usage associated with the requesting system.

Other embodiments are also within the scope of the invention.

### BRIEF DESCRIPTION OF THE DRAWINGS

FIG. 1 depicts an exemplary electronic document including a targeted advertisement according to an embodiment of the present invention.

FIG. 2 depicts an exemplary electronic document including a targeted advertisement and a trademark disclaimer according to an embodiment of the present invention.

FIG. 3 is a schematic of a system for providing targeted advertisements according to an embodiment of the present invention.

FIG. 4 depicts a networked environment in which the system of FIG. 3 may operate according to an embodiment of the invention.

FIG. 5 shows an embodiment of an Advertising Listings Provider of FIG. 4 according to an embodiment of the invention.

FIG. 6 is a flow chart illustrating a method of selectively providing a trademark disclaimer for a targeted ad based at least in part on the location of the user according to an embodiment of the invention.

FIG. 7 depicts an exemplary electronic document including a targeted advertisement and a disclaimer according to an embodiment of the present invention.

### DETAILED DESCRIPTION OF EXEMPLARY EMBODIMENTS

The embodiments described herein solve many problems with existing systems and methods. One problem facing advertisers and content providers is that the trademark laws of some jurisdictions prohibit associating trademarked concepts (or trademarked portions of concepts) with commercial entities other than the trademark holder of the concept. As used herein, the term “concept” may refer to subject matter, one or more keywords, one or more locations in semantic space, or any other concept. As used herein, a “trademarked concept” may include a concept that comprises a trademarked word or term, such as a trademarked keyword. Moreover, the term “trademark” is used for convenience but it should be appreciated that the term also covers service marks, trade dress, trade names, certification marks and other forms of intellectual property in various countries.

For instance, some jurisdictions may prohibit (under certain circumstances) associating trademarked terms with an unrelated advertiser when such an association might lead to a likelihood of “consumer confusion.” In other circumstances in those or other jurisdictions, trademarked terms may be used in “comparative advertisements,” which explicitly compare a trademarked product or service with an advertiser's competing product or service. For example, a comparative ad might state that “ABC Co's breakfast cereal contains 10% more vitamins and minerals than XYZ Co's breakfast cereal.” Because comparative ads distinguish the trademarked product or service from the competing product or service, they are unlikely to create consumer confusion. Other jurisdictions may determine that trademark infringement occurs through use of the trademark (and other factors), regardless of whether any likelihood of consumer confusion exists.

Thus, liability for trademark infringement can depend on a variety of factors, including the presence of an actual trademark, the law of the applicable jurisdiction, the type of advertisement, and the relationship between a specific advertisement and any applicable trademark. Oftentimes, determining potential trademark infringement involves applying legal knowledge to a variety of facts and circumstances. Making such a determination can require significant time and expense.

Although content placed on the Internet is generally available to all networked users, regardless of country and jurisdiction, different trademark laws of those various jurisdictions may govern content provided to users in those jurisdictions. The existence of different legal regimes makes it difficult for content-providers to apply a single advertising policy for all users that considers the trademark laws of all jurisdictions. For one thing, each legal regime recognizes a different set of trademarks. Also, because some jurisdictions place more significant limits on advertising, it is undesirable to implement a unified approach because it would effectively conform to the standards of the most restrictive regime. This would result in a decrease in ads and ad revenue.

When an advertisement or other content may be or is alleged to be in violation of trademark law, some advertisers have elected to participate in a “notice and takedown” compliance procedure wherein the party hosting content infringing a trademark removes the content after receiving notice of the potential trademark violation. In the case of targeted ads displayed by search engines, the search engine may automatically remove the concept from being associated with the advertisement after notice of potential infringement. Such an approach is over-inclusive because it results in the takedown of lawful ads. Search engines may also manually review the potentially infringing ad or concept, determine whether a trademark violation exists and remove ads manually selected based at least in part on perceived questionable use of trademarks. This approach involves a large investment in manpower to review the sites and content, and it also requires some knowledge of trademark law in each jurisdiction.

In response to these and other problems recognized and described herein, an embodiment of the present invention provides for a system for selectively delivering documents (e.g., targeted advertisements) based at least in part on various trademark issues and/or based at least in part on the location of an entity such as an end-user and/or the system to which the advertisement is delivered (e.g., user computer, web server, router, etc.). One iteration of this process involves deciding whether to transmit a legal information communication, such as a disclaimer or acknowledgment or verify record of an acknowledgment associated with the user/system. That decision may be based, at least in part, on whether the location is determined to be in a disclaimer/acknowledgment jurisdiction. A disclaimer/acknowledgment jurisdiction may be determined to be one where there is potential liability if the advertising system or document delivery system delivers documents or advertisements based at least in part on inputs that may include trademarks, but that a disclaimer/acknowledgment mitigates potential consumer confusion. For example, one disclaimer/acknowledgement jurisdiction might be the United States where the legal standard for infringement of a trademark requires evidence of a likelihood of confusion that a disclaimer would help to preclude. A disclaimer/acknowledgment jurisdiction may also be determined to be one in which a disclaimer/acknowledgement limits or reduces the likelihood of a finding of liability under the jurisdiction's trademark laws either for the advertiser, document provider, advertising system or document delivery system. Other criteria for determining a disclaimer/acknowledgement jurisdiction may also be used within the scope of the present invention.

This and other embodiments of the invention are useful for reducing the likelihood of a finding of trademark infringement for content provided over the Internet, such as an advertisement or other document provided with a search result in response to a user's search query. While the term “advertisement” (and “targeted advertisement”) is used herein, it should be appreciated that the systems and methods described may apply to other documents and communications. Similarly, in several places, the term “document” is used, and it should be appreciated that an advertisement is one type of document or portion thereof encompassed by that term and that other communications may also be encompassed. Other terms related to “document” and “advertisement” should be similarly construed, e.g., an “advertiser” is one example of a document provider. It should also be appreciated that the term “document” may also include a portion of a document or other communication.

According to an embodiment of the invention, content providers such as search engines may provide a disclaimer/acknowledgment with targeted ads or other documents indicating that the ads (or documents) are not necessarily sponsored by any holder of a trademarked search term, or that the ad is a comparative or competitive ad. Disclaimers may be prominently displayed to ensure that consumers will not be confused and that trademarks will not be infringed. Acknowledgments may be based at least in part on stored information about a user or system or may be received prior to use of the content provider system or other system where the user is to receive the targeted ads or other documents. For example, an acknowledgment may be prominently displayed prior to use of a system and may request input from the user before some action is undertaken by the system. Throughout this document, the term “disclaimer” and “acknowledgment” may be used. It should be appreciated that an acknowledgment may be used in addition to or in place of a disclaimer and vise-versa. For convenience, throughout this application the term “legal information communication” may be used to include both disclaimers and acknowledgments.

While legal information communications may enable the content provider to comply with various laws in a variety of jurisdictions, they are not effective everywhere. Also, legal information communications take up valuable real estate on a content page or other document. Perhaps purposely, visual confusion-reducing mechanisms may distract the user's attention away from the ads. Advertising content of an advertisement may be diluted when a visual legal information communication is inside an ad. When a prominent legal information communication effectively takes the top spot in a list of ads, that legal information communication may cause each of the ads to effectively move down one spot. Because search results and advertisements listed further down a page are less likely to be selected, this can decrease the CTR of the ads. As many users are disinclined to look at or select an ad even when a legal information communication is not present, such users are even less likely to do so when the presence of one or more legal information communications (e.g., disclaimers) clutter the ads.

Advertisements may be targeted to search results and/or other content pages (e.g., web pages, emails, print media, etc.) on a wide variety of sites and other display environments. Generally, web site providers make advertising space available on their sites as a source of revenue. The more the end-user is interested in an advertisement, the more likely the end-user will select the advertisement. By selecting the advertisement, the end-user obtains more information about the product or service being offered and will more likely become a customer. To be competitive, advertising web sites seek to increase the number of times an end-user selects an advertisement relative to the number of impressions the advertisement gets on the site. This statistic may be referred to as a click through rate (CTR). By increasing the CTR, advertisers will be more inclined to advertise on these web sites. The presence of legal information communications may decrease overall CTR or the CTR for labeled ads. Also, in some systems, advertisers pay the advertising system based at least in part on other performance criteria such as conversion rate and the like. While various examples herein are described relative to CTR, it should be appreciated that the conversion rates and performance criteria also apply.

Content-targeted text advertisements may be displayed when the text advertisements relate to the content that the end-user is currently viewing. The content may be accessed by viewing (or listening to) the content by moving a cursor over an associated icon, entering an input at a keyboard or other input device, touching an identifier on a screen such as a hyperlink, or otherwise selecting the content. The content may also be accessed by actively searching for it, such as by entering a search query at an Internet search engine.

Targeted may be targeted based at least in part on a subject the end-user searched for or the web content the end-user is currently viewing. The targeted advertisements, subject matter, and/or content may or may not involve trademarks. Advertisers may purchase content-based concepts, such as keywords or locations in semantic space (a measure of concept relatedness), in some fashion and associate an advertisement with the concepts so that the advertisements may be displayed in connection with relevant content thereby increasing the CTR or other performance parameter. In another example, advertisers may associate advertisements with content pages, identified by content-based concepts. For example, a third party document supplier (e.g., an advertiser) may want to associate a document (e.g., an advertisement) with a subject matter, e.g., baseball, where the resulting content pages may not necessarily have the term “baseball” located anywhere on the content page. Therefore, content-based concepts may refer to search term matches as well as concept or subject matter matches, not limited to mere word matches.

The advertiser may specify a target language and/or target countries. In addition, the advertiser may target a type of customer based at least in part on demographic and/or other data. Further, the advertiser may intend the advertisement to be displayed on documents such as content pages, results of search pages, sounds, and/or other types of audio-visual outputs (as used herein, the term “document” may refer to one or more of these outputs). Content pages may refer to any page that contains content, including web pages, emails, print material or other media. For example, advertisements directed to children may be restricted from display on adult sites or sites that promote violence. The advertiser may selectively choose whether to allow the advertisement to be displayed on syndication sites. Syndication sites may refer to third party websites that receive advertisements from the provider (e.g., for compensation). In addition, the advertiser may be asked to accept a contract that would free the server from copyright and/or trademark restrictions associated with storing and displaying a copy of the graphic (e.g., logo, trademark, etc.).

An advertiser may represent an entity providing a service and/or product, such as a merchant. The advertiser may also represent an advertising agent or other entity acting on behalf of the advertiser. (Merchants, agents, and other associated entities are individually and collectively referred to as “advertiser” herein.) The advertiser may be a commercial, private, non-profit, government or other type of entity.

The advertiser may identify one or more concepts, which can trigger a display of the advertisement. By specifying concepts, the advertisement will be displayed when an end-user expresses interest in subject matter associated with the concepts. For example, a food delivery service may select keyword concepts such as “food” and “delivery” thereby increasing the likelihood of display of a relevant advertisement. When an end-user is searching for web pages associated with “food” and “delivery,” an advertisement associated with the food delivery service may be displayed. Additional groups of concepts may be applied as well. The same food delivery service may select additional groups of concepts to include other concepts, such as “grocery” and “deliver” and may also include another group, which may include a key phrase, such as “food delivery service in Baltimore area.”

In another example, the advertiser may select from a group of potential concepts. For example, a server may automatically extract keywords and other concepts from the advertiser's website or other designated web page or other location. A list of potential concepts may be displayed for the advertiser to select from. Other methods for associating concepts (e.g., keywords, subject matter, location(s) in semantic space, etc.) with a graphic may be implemented.

In another example, an advertiser may specify content-based concepts directed to a subject matter. For example, an advertiser for car repair service may want to display an advertisement on web pages directed to car repair where the terms “car” and “repair” may or may not appear in the content pages. Content-based concepts are generally not trademarked and therefore do not typically cause additional risk of trademark infringement.

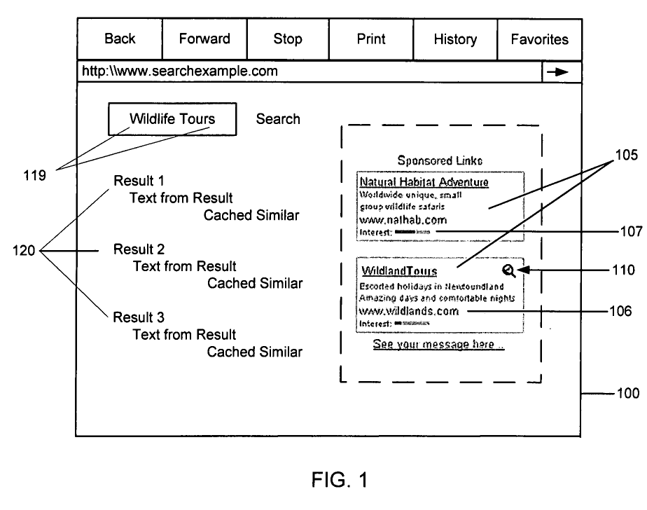

FIG. 1 depicts an exemplary electronic document 100, e.g., web page, email, electronic newsletter, search result, etc., that includes one or more advertisements. There are two advertisements 105 shown in the diagram, although fewer or more may be provided within the scope of the invention. Such advertisements may appear on the electronic document (e.g., web page) to alert a user that certain goods or services are available. Specifically, the company and/or products in the advertisements may relate to the contents of the electronic documents.

The example shown in FIG. 1 depicts an exemplary search result page generated by a search engine provider in response to an input 119 (e.g., a search query). One or more search results 120 are generated based at least in part on an input 119. Here, the input 119 comprises the search string “Wildlife Tours,” although the input 119 may comprise any words, phrases, numbers, or graphics. The displayed search results 120 may comprise websites or other information relevant to the input 119.

The advertisements 105 may be targeted ads, i.e., ads that are conceptually associated with the input 119. Here, the ads for “Natural Habitat Adventure” and “Wildland Tours” both relate to tours involving wild animals and are therefore conceptually associated with “Wildlife Tours.” However, if the input 119 comprises a trademark, then there could be a risk of trademark infringement. For instance, if the advertisement for “Wildland Tours” caused consumers to confuse “Wildlife Tours” with “Wildland Tours,” then the posting of the advertisement may be in violation of trademark laws. Whether there is such a violation depends on the relevant jurisdiction (e.g., the jurisdiction of the user), because there can be no liability for consumer confusion unless the trademark law of the relevant jurisdiction imposes liability for consumer confusion.

One or more of the advertisements 105 may comprise a morphing advertisement as described in U.S. application Ser. No. 10/748,682 entitled “System and method for delivering internet advertisements that change between textual and graphical ads on demand by a user.” Specifically, a morphing advertisement may comprise an advertisement that changes from a first display format to at least one other display format. The advertisement may be displayed in any format, including a morphing or expandable ad format. As depicted, the display format for the advertisement 105 may comprise textual information about the advertiser and/or its products or services. In addition, an expansion icon or other control element 110 may be provided to enable a user to request the transition of advertisement 105 into a second display format (e.g., a more detailed textual format, a graphical format, or a menu-driven interface format, just to name a few). The ad may contain hyperlinks so that a user who clicks on (or otherwise selects) the text, icon, or web address may be directed to the advertiser's (or other affiliated entity's) web page.

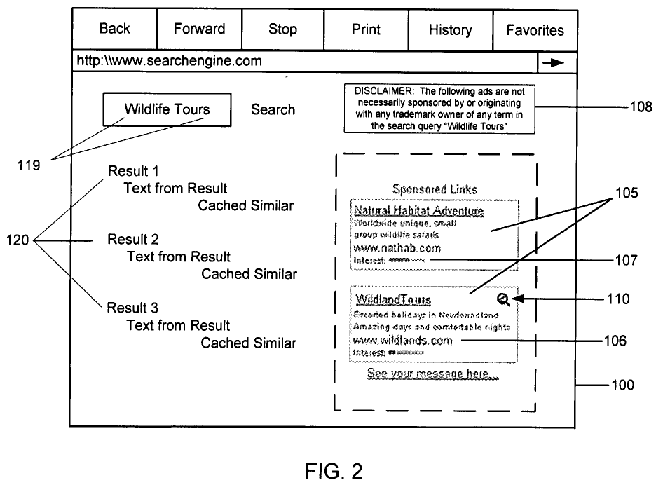

FIG. 2 depicts an exemplary electronic document including a targeted advertisement and a trademark legal information communication 108 according to an embodiment of the present invention. This figure is identical to the electronic document of FIG. 1 except that it includes a trademark legal information communication 108. As discussed above, legal information communication may comprise any disclaimer or acknowledgment language as described herein. The trademark legal information communication 108 may communicate that the advertisements are not associated with any and/or all other content on the page, such as the input 119, search results 120, and/or other advertisements. In an exemplary embodiment, the, trademark legal information communication 108 indicates that the advertisements may not be associated with any trademark named or suggested by the input 119. The trademark legal information communication 108 may also comprise an indication that the advertisement is a comparative advertisement, such as an advertisement comparing the advertiser's product with that of a trademark holder. There may be more than one trademark legal information communication 108. For instance, there may be a trademark legal information communication 108 for each advertisement 105.

While an example legal information communication is disclosed, those in the art would appreciate that variations on the legal information communication message are within the scope of the present invention. Also, different messages/legal information communications may be used for different countries, users, etc.

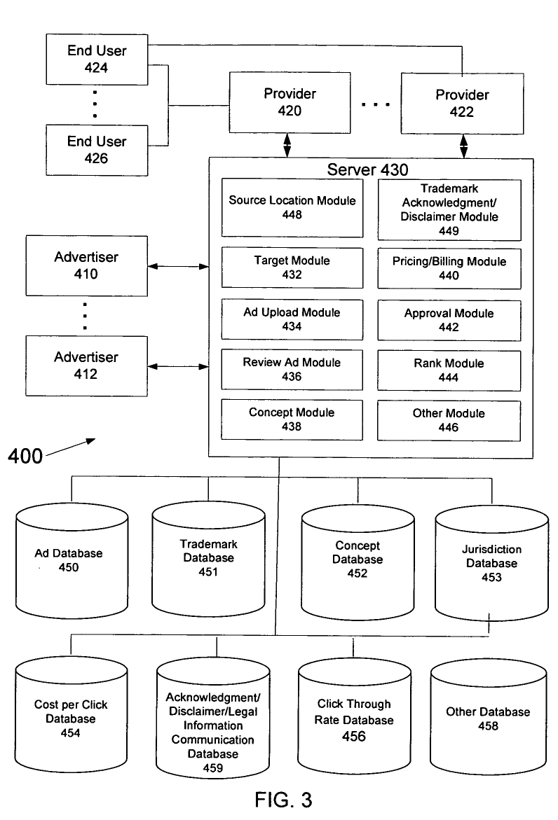

FIG. 3 is a schematic of an embodiment of a system for selectively providing trademark legal information communications with targeted advertisements. System 400 enables an advertiser to input an advertisement and associate the advertisement with content-based concepts for triggering targeted display of the advertisements. Advertisers 410, 412 may communicate with one or more servers 430 via electronic communication, including Internet communications. Providers 420, 422 may include or have access to one or more servers 430 for providing functionality associated with targeted advertisements. Providers 420, 422 may operate separately or in combination with server 430. Providers 420, 422 may provide content pages, search results and/or other types of pages to one or more end-users, illustrated by 424 and 426. Providers 420, 422 may represent any content provider, search engine or other entity that makes available information, services, and products over an electronic network, such as the Internet. Additional participants may be included based at least in part on various applications. For example, multiple advertisers, providers and end-users as well as multiple servers, modules and databases may be implemented.

Server 430 may include various modules for providing functionality associated with targeted advertisements, including trademark legal information communication module 449, source location module 448, target module 432, graphic upload module 434, review graphic module 436, concept module 438, pricing/billing module 440, approval module 442, rank module 444, and one or more other modules 446. The modules may function separately or in various combinations. While the modules are shown within a single server, the modules may also operate among several servers. The modules may communicate with a plurality of databases, which may also function collectively or separately. Databases may include graphic database 450, concept database 452, price parameter database 454, performance parameter database 456, jurisdiction database 453, trademark database 451, legal information communication database 459, and one or more other databases 458. The modules of server 430 may store, access and otherwise interact with various sources of data, including external data, databases and other inputs.

For example, server 430 may receive a request from Provider 420, 422 (or other requester) for an advertisement associated with a concept. Server 430 may also receive another input that triggers delivering an advertisement or other content. In response to the request, the server may deliver an advertisement associated with the concept where the advertisement is positioned for display based at least in part on a ranking among advertisements for the concept. The server 430 may store information in one or more databases.

Jurisdiction database 453 may store information related to one or more jurisdictions such as legal- and/or trademark-related information. A jurisdiction may comprise any definable area in cyberspace or real space. The jurisdiction may be a country, region, state, county, city, district, street address, or other geographic identifier. For instance, a jurisdiction may comprise the United States or the city of Shanghai, China. A jurisdiction may have a well-defined geographical boundary. The jurisdiction may also comprise a group of computers that are linked in a specific way on a network, or it may comprise a group of users with associated IP addresses. For instance, this information may comprise a list of country codes that can be used to determine the country of origin of a request for an advertisement. The jurisdiction database 453 may comprise a list of static IP addresses of Internet access devices known to be in a particular jurisdiction. It may also comprise rules or other data for determining the jurisdiction of an end-user. For instance, the jurisdiction database 453 may comprise data indicating that all IP addresses (or other information relating to a particular end-user) of a particular type correspond to locations in a particular jurisdiction like the United States.

Jurisdiction database 453 may also store rules or other information regarding whether to include a trademark legal information communication with one or more advertisements. The rules may correspond to policies such as best practices (or recommended practices) for avoiding trademark infringement in the jurisdictions. For instance, one rule may specify not to provide any advertisements with a search result.

The jurisdiction database 453 may associate such rules with a definable area, such as an area in cyberspace or the physical world (e.g., a jurisdiction). For instance, one rule may require providing particular legal information communication with all advertisements delivered to users in Germany.

Rules for a particular jurisdiction may be applied to an entity (e.g., an end-user) located in that jurisdiction, provided that the location (in cyberspace or geographic space) of the entity is determined. For instance, if a user is determined to be in Germany, the above rule may require providing a legal information communication with any ad provided to the user. The entity may comprise an end-user 242 or an end-user's computer, phone, handheld device, or other means by which the user 424 accesses the provider 420, 422 or server 430. The entity's location may be defined by country, region, state, county, city, district, street address, IP address, or other geographic or cyberspace identifier.

One rule may specify providing targeted advertisements with a particular trademark legal information communication. Another rule may specify providing targeted advertisements with another trademark legal information communication. Trademark legal information communications may be differentiated based at least in part on legal content, words used, language (e.g., Spanish), format, location on a search result page, graphical content, and number of legal information communications provided (such as one legal information communication for each advertisement, or one legal information communication for all advertisements collectively).

Another rule stored in the jurisdiction database 453 may specify providing a separate trademark legal information communication with each ad. Another rule may specify not to provide advertisements that are associated with any concept (or related term) stored in the trademark database 451.

The trademark database 451 may contain a list of trademarks, service marks, and/or owners of trademarks and service marks. The trademark database 451 may associate each trademark (or service mark) with its trademark owner. The trademarks may be all the trademarks recognized by one or more jurisdictions, such as countries. For instance, the trademark database 451 may contain all of the trademarks registered and/or applied for with the United States Patent and Trademark Office. The list of trademarks, service marks, and owners may be updated periodically. The trademark database 451 may also contain a separate list of trademarks owned by advertisers that provide advertisements to the server 430. These trademarks may also be associated with their corresponding owner.

The legal information communication database 459 may comprise a list of legal information communications associated with various criteria such as country, advertisement or other content type, trademark type, document type, and/or other criteria. For instance, the legal information communication database 459 may comprise one particular legal information communication that is associated with documents containing search results of registered trademarks in France wherein the advertisement comprises the registered trademark. In an exemplary embodiment, the legal information communication database 459 has plurality of legal information communications corresponding to a plurality of jurisdictions, where each legal information communication was determined to comply (or best comply) with the laws of the corresponding jurisdiction. Additional legal information communications may be included for best complying with a particular circumstance as specified by the various criteria.

Other databases are provided. Graphic database 450 may store graphics, including images, animations, sound files, and/or other display options, associated with various advertisers and/or other entities. Concept database 452 may store one or more concepts (e.g., keywords, subject matter, locations in semantic space, etc.) and multiple groups of concepts that may be associated with a graphic and/or advertiser. Price parameter database 454 may store data associated with cost per click (or other price parameter), including bid amounts, for each graphic and/or advertiser. Performance parameter database 456 may store data associated with click through rate (or other performance parameter) for each graphic and/or advertiser.

Source location module 448 may identify the physical or virtual location of an end-user 424, 426. For instance, the source location module 448 may identify the IP address of a specific end-user 424. The source location module 448 may also identify the physical location of the user 424 or the user's computer, phone, handheld device, or other means by which the user accesses the provider 420, 422. The location may be a country, region, state, county, city, district, street address, or other geographic identifier. Such information may be identified automatically when the end-user 424 accesses information from the server 430 (or inputs information to the server 430), e.g., via the provider 420, 422. Alternately, the provider 420, 422 may provide such location information to the server 430, e.g., upon request of the server 430.

The trademark legal information communication module 449 may determine information regarding an advertisement or a legal information communication, which may be provided with an advertisement in response to a search request or other ad-triggering event or input. For instance, the trademark legal information communication module 449 may determine whether to include a trademark legal information communication with an advertisement (e.g., a targeted ad provided in response to an end-user's 424 input, such as a search query at a search engine provider). The trademark legal information communication module 449 may process any of the following: one or more advertisements, user input (such as a search query), other user information (such as user location information), advertiser information, provider information, information processed by the source location module 448, information stored in the jurisdiction database 453, information stored in the legal information communication database 459, and/or information stored in the trademark database 451.

The trademark legal information communication module 449 may process such information to determine any of the following: whether a request, input, search query, or concept comprises a trademark, such as a trademark associated with or recognized by a particular jurisdiction; whether a request, input, search query, or concept comprises one or more terms that are associated with a trademark (e.g., that are nearly identical to or confusingly similar to a trademark); whether a location (e.g., a user location) is in a particular jurisdiction; whether a request, input, search query, or concept comprises (or is associated with) any trademarks in a particular jurisdiction, such as the jurisdiction governing the user's location. The trademark legal information communication module 449 may also process such inputs to determine: a trademark in (or associated with) a request, input, search query, or concept; legal information associated with the jurisdiction of a location; a disclaimer; a type of disclaimer; and/or the format of a disclaimer (e.g., size, color, position, etc.).

For instance, the trademark legal information communication module 449 may process user location information from the source location module 448, search query input from a user, and trademark information from the trademark database 451 to determine whether the user's search query contains a trademark that is recognized in the jurisdiction of the user's location. Based at least in part on this determination, the trademark legal information communication module 449 may then determine whether to include a legal information communication with a targeted ad, and if so, it may determine the content of the legal information communication. The trademark legal information communication module 449 may also access the legal information communication database 459 to select the content of the legal information communication based at least in part on various criteria.

Target module 432 enables an advertiser (e.g., 410, 412) to specify a target intended audience. For example, the advertiser may specify a preferred language, country or other demographic preference. The advertiser may want to reach potential customers through a content page, search results page and/or other type of page. The advertiser may also specify if the graphic will be displayed on syndicated sites. In addition, the advertiser may not specify any target audience or any limitation.

Ad upload module 434 enables an advertiser to upload information for an ad, including text, graphics, one or more links to which a user is to be directed upon selection of the advertisement, etc. The information may be uploaded by identifying an address (e.g., URL address, etc.). The graphic may be downloaded from the advertiser's website or other associated site. The graphic may be retrieved from a database or other source. The graphic may include various visual options, including animation, pop-up ability, sound waves, etc. and may also include text, including text advertisement. The server may size or shape the graphic to fit a predetermined size or shape. In addition, the advertiser may select from a selection of sizes and/or shapes for display. For example, the advertiser may be willing to pay more for a larger size graphic rather than settle for a smaller standard size. By enlarging the graphics, an advertiser may increase potential click through by end-users.

Review ad module 436 enables an advertiser to review how the information presented for the ad may look when presented to users. The advertiser may approve the ad, make additional modifications or simply identify and upload a new ad.

Concept module 438 enables an advertiser to identify one or more content-based concepts (e.g., keywords, subject matter, location(s) in semantic space, etc.) for association with the uploaded graphic. For example, the advertiser may identify multiple groups of concepts. The concepts may be used to target the graphics to improve potential click through rate. For a search result page, if the search terms entered by an end-user substantially match the concept(s), an associated graphic may be displayed on a search result page based at least in part on a rank. For a content page, if the content page matches the concepts (e.g., subject matter), an associated graphic may be displayed on a content page based at least in part on a rank. In addition, an advertiser's web site (or other associated or identified site) may be accessed to retrieve terms and/or phrases throughout the sites or designated pages to formulate a list of potential concepts. The advertiser may select concepts and/or otherwise identify relevant subject matter from the list.

Pricing/billing module 440 enables an advertiser to specify cost data and/or other price parameter. For example, an advertiser may specify a maximum price the advertiser is willing to pay for each time the advertisement is selected. For example, the advertiser may specify a daily budget. The advertiser may also make modifications to the cost data.

Approval module 442 may review and/or enable users to review content of an advertisement, such as the graphic and/or textual information provided, for offensive and/or inappropriate material as well as relevancy. For example, the ad may be reviewed for nudity, violent images (e.g., guns, etc.), and other offensive images and/or graphics. The review process may also be tied to an intended audience, such as children, young teens, etc., where sensitive graphics and/or images may be more closely scrutinized. This review process may be automatic. In addition, the ads may be reviewed for relevancy to the advertiser or intended advertisement as well as the keywords and concept targeting. This aspect of the review process may be manually or automatically performed to ensure that relevant ads are displayed in connection with content pages, search result pages and/or other pages.

Rank module 444 may determine a rank of the advertisement. The rank of the advertisement may refer to the placement of the advertisement relative to other advertisements related to the same or similar concepts. Generally, the higher (or more prominently) the advertisement is displayed, the more likely an end-user will be to take notice, thereby improving the potential for a click through (e.g., an end-user clicking on the advertisement). According to one example, the ranking of the advertisement may be determined by multiplying a price parameter (e.g., the cost per click) and the performance parameters (e.g., click through rate). Other methodologies for ranking advertisements may be implemented. For example, other price parameters and/or performance parameters may be considered.

In addition, rank module 444 may also determine a position for the advertisement. Some advertisements may be displayed as a banner, across the top of a page (e.g., search page, content page, etc.), along the side of search results, and anywhere else on the page.

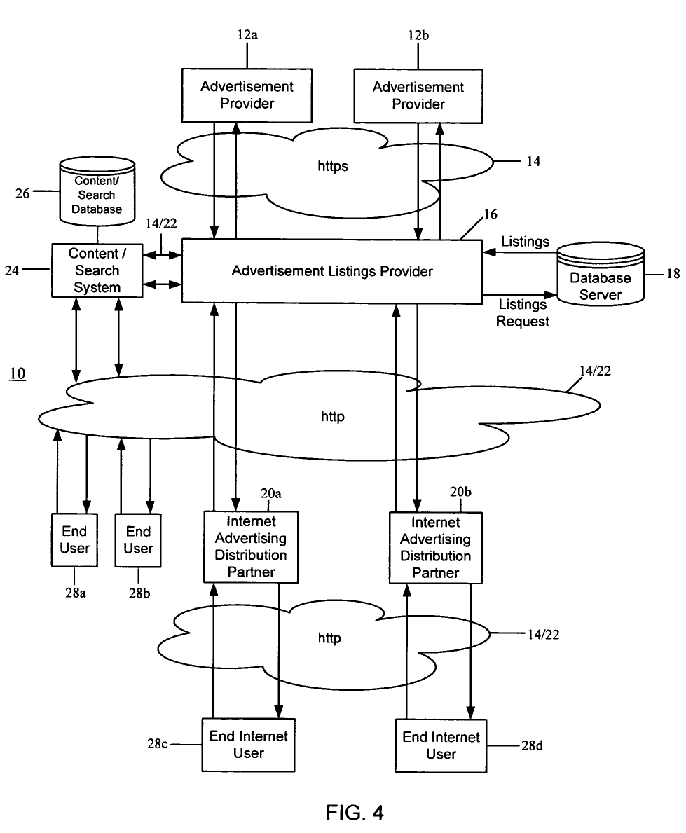

FIG. 4 depicts a networked environment in which the system of FIG. 3 may operate according to an embodiment of the invention. In such an environment, advertisement providers 12 (or other document providers, hereinafter advertisement provider 12) connect over a network 14 to an advertisement listings provider 16 (or document delivery provider 16, hereinafter advertisement listings provider 16) (e.g., using a secure https connection) to register, provide payment information, one or more price parameters (e.g., an amount an advertiser is willing to pay for each click, bid amount, price information, other measure of price, etc.) and associated advertisements (also called “creatives”) associated with the price parameter. For example, the advertisers may provide their price parameter(s) in association with a concept for use in a search engine system and may also provide a price parameter in association with content on a content portal or content distribution system. The advertisement listings provider 16 then stores the information on a database server 18 for later transmittal. The advertisement listings provider 16 may then distribute the listings through various forums or feeds, including direct distribution in print media, providing the listings on one or more web sites affiliated with the advertisement listings provider, through internet advertising distribution partners 20 (also called syndication partners) (connected over network 14 or 22 depending on security desired), through content systems 24 (with associated content databases 26) and through search engine systems operated by the advertisement listing provider or internet advertising distribution partner(s).

Through these various forums, the advertisements provided by the advertisement provider 12 may be included in pages (or other documents) displayed to end-users 28 (often called an impression). In an exemplary embodiment, the advertisement provider 12 is only obligated to pay if the end-user meets some performance parameter (e.g., clicks-through the advertisement to the web page target provided by the advertisement provider in affiliation with the particular ad, activates a coupon, becomes a registered user, purchases an item, completes a phone link (in the event of a wireless/phone hookup), for example). In addition, the advertisement listings provider 16 may only be paid when a certain performance parameter is achieved (e.g., a click-through occurs or a conversion occurs, etc.) or some other monetization event occurs. Also, traditionally, the advertisement listing provider 16 and internet distribution partner(s) 20 may agree to share the revenue for the charge-incurring performance (e.g., click-throughs generated) through distribution via the internet distribution partner 20.

Each of advertising listings provider 16 and advertisement provider 12 may comprise computerized systems that include one or more of the following systems: a web server, a database server, proxy server, network balancing mechanisms and systems, and various software components that enable the system to operate on the internet or other network type system. Additionally, networks 14 and 22, although depicted as http networks, may comprise other networks such as private lines, intranets, or any other network. In an exemplary embodiment, the connection between advertising provider 12 and advertisement listing provider 16 may comprise secure network connections to insure that data is not subject to attack or corruption by any hacker or other third party. In addition, whereas two advertisement providers are depicted, it should be appreciated that one or more advertisement providers 12 may be provided in the network. Similarly, although one database server 18 is depicted, it should be appreciated that multiple database servers may be provided and that such database servers may be connected to the advertisement listing provider via any type of network connection, including a distributed database server architecture.

Similarly, content system 24 and content database 26 may comprise any number of such systems connected to the advertisement provider or advertisement listing provider 16 via any type of network, including an http or https network. Content provider 24 may comprise a system such as advertisement listing provider 16 that provides functionality for enabling connection over the internet or other network protocols. End-users 28 may comprise any user connected to the internet and may comprise computerized systems that enable that connection through any of various types of networks, including through internet service providers, cable companies, and any other method of accessing data on the internet. Internet advertising distribution partners 20 may comprise any system that distributes internet-based advertising to end-users. Whereas two internet advertising distribution partners 20 are depicted, any number may actually be provided.

In general, in these embodiments, the advertisement listing provider 16 generates revenue when end-users achieve performance parameters or some other monetization event (as discussed above) occurs relevant to an advertisement such that the advertising system can charge a price parameter participating advertisement providers select. The advertisement listing provider 16 may also incur costs for every impression that it reaches in the form of overhead in running a web site or distribution agreements for distribution. Accordingly, the various embodiments of the present invention recognize that in such systems, it is the revenue per specific page served (effective revenue per impression) that generally produces the advertisement listing provider's profits (also called page real estate revenue efficiency). By using page real estate revenue efficiency to rank advertisements then, the advertisement listing provider's rankings track its own profitability. This is particularly true for distribution channels with limited numbers of slots for advertisements.

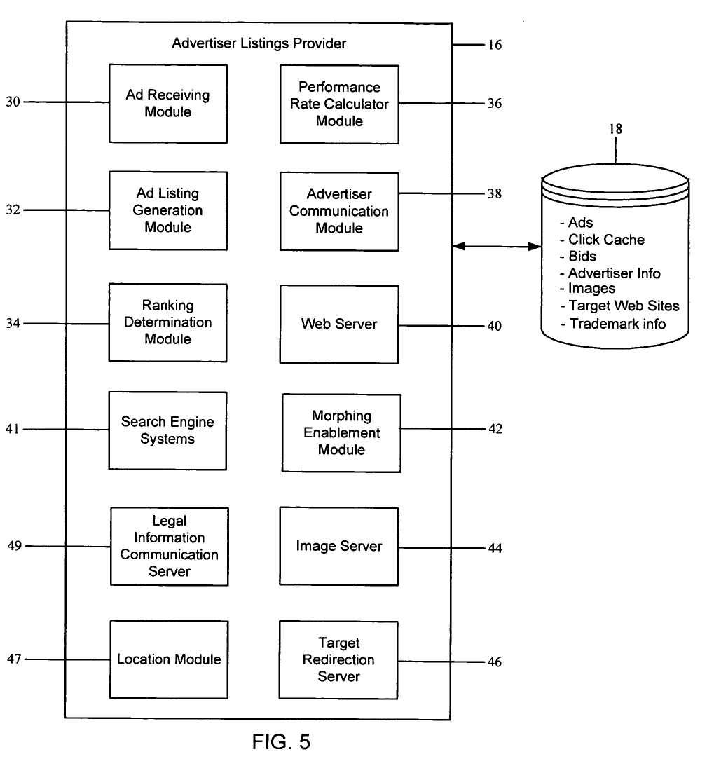

FIG. 5 shows an embodiment of an advertiser listings provider 16 in more detail. As shown in FIG. 4, the advertising listings provider 16 may comprise a system that provides an advertisement receiving module 30 for interacting with advertising providers to receive advertisement information.

The advertising listings provider 16 may comprise a location module 47 configured to determine the location of a user or other entity and any legal information communication rules or criteria associated with the location. The location module 47 may accomplish one or more of the functions of the source location module 448.

The advertising listings provider 16 may comprise a legal information communication server 49. The legal information communication server 49 may be configured to accomplish any of the functions of the trademark legal information communication module 449 (see FIG. 3). For instance, the legal information communication server 49 may determine: whether an advertisement or concept comprises (or is associated with) a trademark; whether to provide a legal information communication based at least in part on the location of an end-user (or other entity) and/or the presence of a trademark in an advertisement or concept (or associated with a concept); and whether to provide a legal information communication for a particular ad or other content. The legal information communication server 49 may further determine the substance and format of the legal information communication and other features, if a legal information communication is to be provided. To accomplish these functions, the legal information communication server 49 may process information stored in the database 18 such as advertiser trademark information.

The legal information communication server 49 may also review ads received from the advertisement provider 12 for trademark content. If the advertisement provider 12 requests to associate an ad with a concept that is identified with a trademark (e.g., a keyword comprising a trademark owned by an entity other than the advertiser), then the legal information communication server 49 may refuse to associate the ad with the concept.

The advertising listings provider 16 may also comprise an advertising listing generation module 32 that generates a listing of advertisements from the database based at least in part on criteria provided and depending on the forum for the advertisements (e.g., search engine, content portal, distribution partner, etc.). A ranking module 34 may generate an order to the listing based at least in part on rankings based at least in part on a model. In an exemplary embodiment, the ranking module 34 may determine rankings based at least in part on price parameter values, revenue efficiency and performance, in conjunction with a performance rate determination module 36 (e.g., a click-through-rate calculator, conversion calculator, coupon selection calculator, phone through rate calculator, etc.). The resulting advertisements generated and ranked may then be communicated through various channels. An advertiser communication module 38 may also be provided for communicating with the advertisers. For example, it may be desired for the system to alert an advertiser prior to changing the advertisement used for a given price parameter or before moving the advertisement down or up in the rankings. A database 18 may be provided in affiliation with the advertiser listing provider to store advertisements, price parameters, advertising information and a cache of clicks to be used to determine the performance-rate.

Additionally, because advertising listings provider 16 may provide the functionality of distributing advertising itself and providing search engine results, web server system 40 may be provided as well as a search engine system 41. It should be appreciated that multiple such systems may be encompassed within the advertising listing provider system 16.

Additionally, a morphing enablement module 42 may be provided that takes data stored for a morphing advertisement in the database system 18 and generates a morphing advertisement for inclusion in an electronic document as described below, for example. An image server 44 may be provided to serve images associated with advertisements, if desired. Also, a target redirection server may receive a target selection from the user system, log the event for billing purposes and redirect the user to advertiser specified content.

Additionally, database server system 18 may comprise one or more database systems that store various types of data including one or more of the following: advertisements, the click cache, price parameter information, and advertiser information including registration information about the advertisers, accounts for the advertisers, payment information and other information as described herein. Numerous modules may not be provided in various embodiments and/or the modules may be combined together to provide the functionality described. Further, the modules may be dispersed across multiple physical systems or may be duplicated across multiple systems.

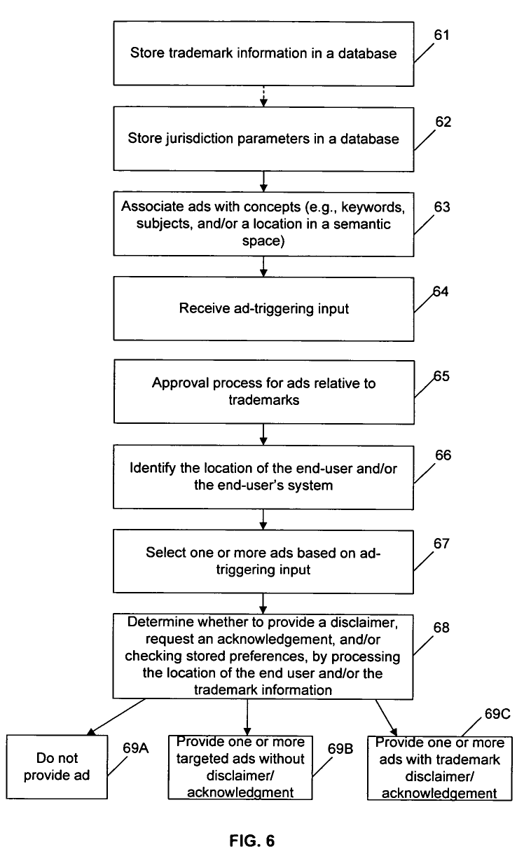

FIG. 6 is a flow chart illustrating a method of selectively providing a trademark legal information communication for a targeted ad based at least in part on the location of the user according to an embodiment of the invention. It should be appreciated that some of these actions are optional, and that they may not necessarily proceed in the order described.

In optional action 61, trademark information may be stored in a database. The trademark information may comprise any information related to trademarks, such as the information that may be stored in the trademark database 451 of FIG. 3.

In action 62, jurisdiction parameters may be stored in a database. The jurisdiction parameters may comprise any information related to a jurisdiction as defined herein, such as information stored in the jurisdiction database 453 of FIG. 3. For instance, the jurisdiction parameters may comprise information defining one or more jurisdictions (such as geographical or IP address information) and rules governing advertisements in one or more jurisdictions.

In action 63, advertisements may be associated with concepts. For instance, an advertiser may associate one or more concepts with a particular ad, so a user inputting the concepts might trigger the ad. Such associations may be stored, such as in a database at the server.

In action 64, ads or other documents may be approved for various levels of distribution based at least in part on various trademark-related criteria, among others. For example, documents (e.g., ads) may be placed into one of three categories: disapproved due to improper use of trademarks, approved for distribution in liberal jurisdictions, or approved for distribution in all jurisdictions. That approval level may then be stored in association with the ad. Approval levels may be automatically generated based at least in part on a textual review of the content of the document or may be based, at least in part, on human evaluation.

In action 65, ad-triggering input may be received. The input may be received from a user or from a content-provider. In an exemplary embodiment, the input is a user search query at a search engine, and the search engine provider's server receives the input. For instance, a search for “lasagna recipe” at a search engine may trigger the search engine to display ads that are related to “lasagna” and/or “recipe.” In another embodiment, the ad-triggering input is a request for an ad from a content provider received an advertisement provider's server. The content provider may request a targeted ad associated with one or more words, numbers, and/or concepts. For instance, the content-provider may request an ad associated with shoes. In all cases, the ad is intended to be displayed to an end-user.

In action 66, the location of the end-user may be identified. A content provider, an end-user's Internet service provider, and/or an advertiser may accomplish this. The location may be determined in any manner as specified herein, such as in the manner described for the source location module 448.

In an exemplary embodiment, the location of the end-user's service provider or the location of a content-provider is determined instead. For instance, if it is impossible to determine the location of an end-user (or to determine the jurisdiction governing the end-user, if any), then the location of another entity may be determined. In an exemplary embodiment, the entity whose location is identified is the entity whose jurisdiction is determined to be a legally significant jurisdiction for purposes of trademark law compliance. The legally significant jurisdiction may be the jurisdiction of the end-user, the jurisdiction of the content provider, or another jurisdiction.

In action 67, one or more ads are selected based at least in part on the ad-triggering input. Methods of selecting ads are described in this and related applications. A ranking system may be used to select the ads. This action 67 may be independent of location identification and therefore may occur before or after action 66.

In an exemplary embodiment, the ads are selected based at least in part on trademark information, such as trademark information stored in the trademark database.

In action 68, the entity that received the ad-triggering event determines which, if any documents (e.g., ads) to provide and if any documents are provided, which, if any, legal information communication(s) to provide. Trademark legal information communication module 449 as described herein may perform the determination. The determination may be based at least in part on, e.g., the ad-triggering event (e.g., user input), the location and/or jurisdiction of the user, the selected ad(s), the advertiser(s) of the selected ad(s), or the identity of the ad-requesting entity. The server may determine whether to provide a legal information communication based at least in part on whether an ad-triggering concept or search query contains a trademarked word by processing the trademark database 451. In this action 68, the server may also determine whether an advertiser (or entity associated with the advertiser) is the owner of a trademark associated with a search query or other triggering concept.

This action 68 may be independent of ad selection and therefore may occur before or after action 67.

For example, in one iteration, there may be at least three outcomes. In the first outcome of action 69A, an ad is not provided. For instance, a request for an advertisement may be denied. In the case of a search query, a search engine provider may provide the search result of the query without providing any ads. This may occur if the location of the end-user is determined to be in a jurisdiction associated with a rule to not provide any ads. This may also occur if the jurisdiction is associated with a rule to provide advertisements of only a particular type, and no such ads are available. For instance, if the rule prohibits ads that contain a particular trademark associated with the ad-triggering input (e.g., a trademarked name in a search query), and if there are no ads that satisfy this criteria, then no ad may be provided.

In another outcome (action 69B), one or more targeted ads are provided without any legal information communication. This may be based, in part, on the approval of the advertisement as being for all jurisdictions, for example. For instance, one or more ads may be passed to an end user along with search results to a user's search query. One or more ads may be also passed to an end user or content-provider for display on another content-provider's web page.

The ads may be in their original form, or they may be amended pursuant to rules, such as rules specified by the trademark legal information communication module 449 of FIG. 3. For instance, a rule may specify that the text of ads of a specific type must not be included in ads intended for end-users in a particular jurisdiction. Such ads might be amended to include only a hypertext link or graphic. The ads may be edited in other ways, e.g., in ways that may help to prevent consumer confusion between the advertisement and another entity, such as a content provider. The ads might also be edited to delete any references to a trademarked term, such as a term registered as a trademark in the jurisdiction of the end-user.

In another outcome (action 69C), one or more ads is provided with a trademark legal information communication. The trademark legal information communication may be any legal information communication as described herein. In particular, the legal information communication may be a legal information communication that is determined to comply (or best comply) with the laws (e.g., trademark laws) of the jurisdiction of the user. The ads may be modified as described above according to the rules of the user's jurisdiction as applied to the particular ad-triggering input and selected (or available) ads. The legal information communication may comprise one or more separate legal information communications. The legal information communication may indicate to an end user that the advertisements are not necessarily related to any other content provided on the web page that contains the advertisements. In an exemplary embodiment, the legal information communication comprises an indication that the advertisement(s) is a comparative advertisement.

The legal information communication may be based at least in part on the input received in action 65 (or a portion of such input). For instance, if the input was a search query that included a trademark, the legal information communication may communicate that the one or more ads may not be associated with the trademark.

In addition, user preferences and/or preferences of Internet advertising distribution partner 20 may be stored for use by server 430. Such preferences may indicate the users and/or distribution partners' acceptance level associated with trademark usage. Thus, one distribution partner may elect to not receive any advertisement unless it has been deemed approved for all jurisdictions. Another distribution partner may elect to receive advertisements that are approved for liberal jurisdictions, but only if legal information communications are provided with the advertisement. The system may then elect to utilize the more restrictive set of rules when determining which, if any advertisements to deliver through that distribution partner and which, if any, legal information communications to include with the advertisements for provision through that distribution partner.

In this example, actions may be taken to selectively deliver documents (e.g., advertisements) and utilize legal information communications (e.g,. delivering a disclaimer or acknowledgment or checking that an acknowledgment has been received from a user/receiving system). A request related to a concept (e.g,. a keyword-based search, an ad request for a content page, a content-based search, etc.) may be received from a requesting system (a user or a distribution partner). Documents (e.g., advertisements) are then identified through various methodologies described herein and others known in the art (e.g., those associated with the keyword, the concept, a related concept or some other method for document identification). A determination is then made as to whether to deliver the one or more documents based at least in part on one or more trademark factors and an acceptance level for trademark usage associated with the requesting system. The acceptance level may indicate the requesting system's willingness to accept documents associated with trademark-related concepts.

In addition, a determination may be made as to whether to include a legal information communication with the document based in part on the acceptance level for trademark usage. These determinations may factor in the location of the requesting system and/or the user to which the document is to be delivered. The determination may consider a trademark usage acceptance level associated with the location as well. In addition, the determination may give priority to one acceptance level over another such that a location acceptance level governs over a receiving user acceptance level or vise versa. Also, multiple acceptance levels may be applied such that the more restrictive level governs delivery and/or utilization of a legal information communication.

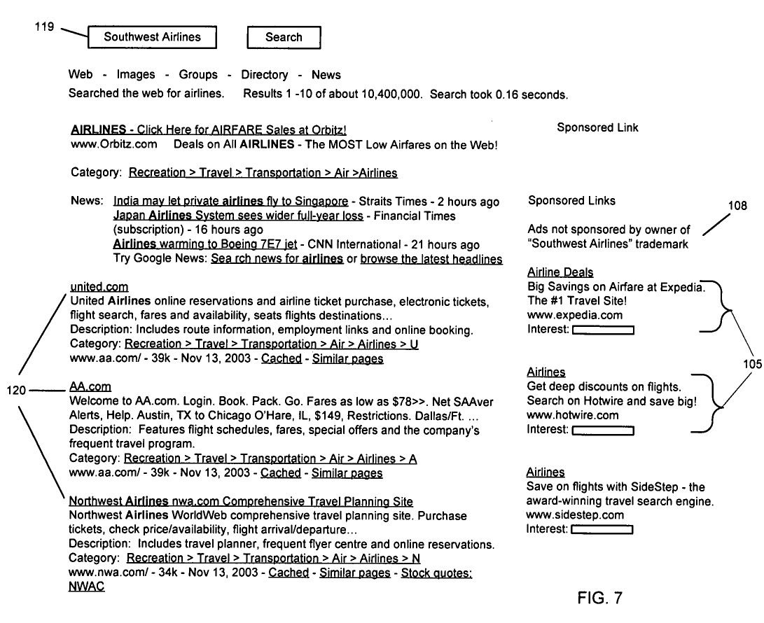

FIG. 7 depicts an exemplary electronic document including targeted advertisements 105 and a legal information communication 108 according to an embodiment of the present invention. Here, the document was generated in response to an input 119 (e.g., a search query), namely “Southwest Airlines.” The document comprises search results 120, advertisements 105 associated with the input 119, and a legal information communication 108. The advertisements 105 comprise various advertisements that are related to the input, such as air travel sites. The legal information communication 108 states that the owner of the “Southwest Airlines” trademark does not sponsor the ads 105. The legal information communication protects the content provider from trademark infringement in some jurisdictions by informing the end-user that the ads may not be associated with a trademark in the end-user's input.

The systems and methods of the present invention may be used to achieve this result as described herein, e.g., in FIG. 6.

It will be apparent to one skilled in the art that the system and methods described herein may also be applied to service marks, trade dress, personal images, and graphics, in addition to trademarks and trademark names.

Accordingly, as described herein, various embodiments are provided. An embodiment provides a method and system for selectively delivering legal information communications for documents. The method involves receiving an input (e.g,. a search query from a user, a keyword associated with the at least one targeted advertisement or a request for an advertisement associated with one or more concepts) from a user at a location, wherein the input is a document-triggering event operative to cause a document to be delivered to a user, identifying the location of the user, determining whether to provide a legal information communication based at least in part on the location, and delivering at least one document (e.g., advertisement or target advertisement associated with one or more concepts) based at least in part on the input, wherein the at least one document is delivered with a legal information communication if the location is determined to be in a legal information communication jurisdiction. The legal information communication jurisdiction may be a jurisdiction that requires a legal information communication to avoid a likelihood of confusion.

When the input is a keyword, the method may also involve associating a keyword with the at least one targeted advertisement and selecting the at least one targeted advertisement for delivery to the user in response to the input, wherein the keyword is associated with the input. The legal information communication may not be delivered with the targeted advertisement if the location is determined to not be in a legal information communication jurisdiction. The legal information communication may indicate, for example, that the at least one targeted advertisement might not be sponsored by any trademark holder. Additionally, the advertisements delivered may be positioned for display based at least in part on a ranking among advertisements for the concept, the ranking being based at least on a price parameter amount. The method and system may also involve a action of approving the advertisement for display for offensive material and for relevancy to the concept with which the advertisement has been associated.

The location of the user and/or user system may involve identifying the Internet protocol address of the source, identifying the country where the source is located or other location identification processes and operations. Also, the advertisement or document may be displayed as part of a content page, search page or other point, all of which may include web pages, email, and/or versions of print media.

The embodiments of the present inventions are not to be limited in scope by the specific embodiments described herein. For example, although many of the embodiments disclosed herein have been described with reference to advertisements, the principles herein are equally applicable to documents and other content. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A method for selectively delivering legal information communications for documents, comprising the steps of:
receiving an input, wherein the input is a document-triggering event operative to cause a document to be delivered to a user;
identifying a location of the user associated with the input;
determining whether to utilize a legal information communication based at least in part on the location; and
delivering at least one document based at least in part on the input, wherein the at least one document is delivered with a legal information communication if the location is determined to be in a legal information communication jurisdiction.

2. The method of claim 1, wherein the legal information communication comprises a disclaimer.

3. The method of claim 1, wherein the input is a search query from a user.

4. The method of claim 1, wherein the input comprises a concept associated with at least one targeted advertisement, and further comprising the steps of:
associating a concept with the at least one targeted advertisement; and
selecting the at least one targeted advertisement for delivery to a user in response to the input, wherein the concept is associated with the input.

5. The method of claim 1, wherein the input comprises a request for an advertisement associated with one or more concepts, and wherein the advertisement is a targeted advertisement associated with the one or more concepts.

6. The method of claim 1, wherein the legal information communication comprises an acknowledgment request.

7. The method of claim 6, further comprising the action of receiving response to the acknowledgment.

8. The method of claim 7, wherein the response is received prior to displaying the document to the user.

9. The method of claim 1, wherein the receiving, identifying, determining, and delivering steps are performed automatically.

10. The method of claim 1, wherein the legal information communication indicates that the at least one targeted advertisement might not be sponsored by any trademark holder.

11. The method of claim 1, wherein the targeted advertisement is positioned for display based at least in part on a ranking among advertisements for the concept, the ranking being based at least on a price parameter amount.

12. The method of claim 1, further comprising the action of:
approving the advertisement for display for offensive material and for relevancy to the concept with which the advertisement has been associated.

13. The method of claim 1, further comprising the action of:
approving the advertisement for trademark usage.

14. The method of claim 1, wherein the determining action comprises identifying the Internet protocol address of the source.

15. The method of claim 1, wherein the determining action comprises identifying the country where the source is located.

16. The method of claim 1, wherein the targeted advertisement is displayed on one or more of a content page and a search result page.

17. The method of claim 15, wherein the content page comprises one or more of a web page, email and print media.

18. The method of claim 1, wherein the advertisement comprises one or more of an image, animation, pop-up ability, sound, voice and music.

19. The method of claim 1, wherein determining whether to provide a legal information communication is further based at least in part on whether the targeted advertisement is a comparative ad.

20. The method of claim 1, wherein the document is an advertisement.

21. The method of claim 1, wherein the document is a targeted advertisement of an advertiser, wherein the targeted advertisement was associated with a concept by the advertiser, and wherein the targeted advertisement is selected to be delivered based at least in part on its association with the concept.

22. The method of claim 20, wherein the concept is at least one of one or more subject matters, one or more locations in semantic space, and one or more key words.

23. A system for selectively providing legal information communications in documents, comprising:
a server that receives input and delivers documents based at least in part on the input to a location, wherein the server utilizes a trademark legal information communication if the location is in a legal information communication jurisdiction;
an identification module that identifies the location; and
a processor that determines whether the location is in a legal information communication jurisdiction.

24. The system of claim 22, wherein the document comprises a targeted advertisement.

25. The system of claim 22, wherein the document comprises a targeted advertisement, and the targeted advertisement is displayed on one or more of a content page and a search result page.

26. The system of claim 23, wherein the content page comprises one or more of a web page, email, and print media.

27. The system of claim 22, wherein the input comprises a search query by a user.

28. The system of claim 22, wherein the document comprises an advertisement, and the advertisement comprises one or more of an image, animation, pop-up ability, sound, voice, and music.

29. A method for selectively providing documents, comprising:
receiving a request for a document associated with a concept, the document to be provided to a user;
identifying a location associated with the request;
determining whether the concept is identified with any trademark recognized by the jurisdiction of the location; and
responsive to a determination that the concept is not identified with any trademark recognized by the jurisdiction of the location, providing a document associated with the concept.

30. The method of claim 28, wherein the document is displayed on one or more of a content page and a search result page.

31. The method of claim 29, wherein the content page comprises one or more of a web page, email, and print media.

32. The method of claim 28, wherein the concept comprises at least one or more keywords entered as a search request.

33. The method of claim 28, wherein the document comprises one or more of an image, animation, pop-up ability, sound, voice, and music.

34. The method of claim 28, wherein the document comprises a targeted advertisement.

35. A system for selectively providing documents, comprising:
a server that receives a request for a document associated with a concept, the document to be provided to a user;
an identification module that identifies a location associated with the request;
a processor that determines whether the concept is identified with any trademark recognized by the jurisdiction of the location; and
an output device that provides a document associated with the concept if the concept is not identified with any trademark recognized by the jurisdiction of the location.

36. The system of claim 34, wherein the document is displayed on one or more of a content page and a search result page.

37. The system of claim 35, wherein the content page comprises one or more of a web page, email, and print media.

38. The system of claim 34, wherein the request comprises a search query by a user.

39. The system of claim 34, wherein the document comprises one or more of an image, animation, pop-up ability, sound, voice, and music.

40. The system of claim 34, wherein the document comprises a targeted advertisement.

41. A method for selectively delivering documents, comprising:
receiving a request for a document associated with a concept;
determining whether the concept is identified with a trademark; and
determining whether to deliver the document based at least in part on whether the concept is identified with a trademark.

42. The method of claim 40, wherein the request comprises a search query from a user.

43. The method of claim 41, wherein the document is displayed on one or more of a content page and a search result page.

44. The method of claim 40, wherein the content page comprises one or more of a web page, email, and print media.

45. The method of claim 40, further comprising the action of denying the request responsive to a determination that the concept is identified with a trademark.

46. The method of claim 40, further comprising the action of determining whether the location is in a legal information communication jurisdiction responsive to a determination that the concept is identified with a trademark.

47. The method of claim 45, further comprising the action of delivering the document with a legal information communication responsive to a determination that the location is in a legal information communication jurisdiction.

48. The method of claim 45, further comprising the action of delivering the document responsive to a determination that the concept is not in a legal information communication jurisdiction.

49. The method of claim 40, further comprising the actions of:
responsive to a determination that the concept is not identified with a trademark:
identifying the location of a user;
determining whether to provide a legal information communication based at least in part on the location; and
delivering at least one document to the user based at least in part on the input, wherein the at least one document is delivered with a legal information communication if the location is determined to be in a legal information communication jurisdiction.

50. The method of claim 40, wherein the document comprises one or more of an image, animation, pop-up ability, sound, voice, and music.

51. The method of claim 40, wherein the document is a targeted advertisement.

52. A system for selectively approving documents for association with a concept, comprising:
a server that receives a request to associate a document with a concept; and
a processor that determines whether the concept is identified with a trademark, wherein the processor is further configured to deny the request responsive to a determination that the concept is identified with a trademark.

53. The system of claim 51, wherein the document is a targeted advertisement.

54. The system of claim 51, wherein the request comprises a search query from a user.

55. The system of claim 51, wherein the documents is displayed on one or more of a content page and a search result page.

56. The system of claim 54, wherein the content page comprises one or more of a web page, email, and print media.

57. The system of claim 51, wherein the request is operative to cause content to be delivered to a location, and wherein the server is further configured to identify the location, determine whether to provide a legal information communication based at least in part on the location; and deliver at least one document based at least in part on the input, wherein the at least one targeted advertisement is delivered with a legal information communication if the location is determined to be in a legal information communication jurisdiction, responsive to a determination that the concept is not identified with a trademark.

58. A method for providing targeted advertisements, comprising the steps of:
storing a list of trademarks and trademark owners in a database;
receiving from an advertiser a request to associate an advertisement with a concept;
processing the database to determine whether the concept is identified with a trademark not owned by the advertiser;
responsive to a determination that the concept is identified with a trademark not owned by the advertiser, denying the request; and
responsive to a determination that the concept is not identified with a trademark not owned by the advertiser, associating the advertisement with the concept.

59. The method of claim 58, wherein the list comprises a list of registered trademarks in at least one jurisdiction.

60. The method of claim 58, further comprising the action of indicating that the advertisement is a comparative advertisement responsive to a determination that the concept is a trademark not owned by the advertiser.

61. The method of claim 58, further comprising the actions of:
receiving a request for an advertisement associated with the concept; and
delivering the advertisement.

62. A method of receiving documents, comprising:
transmitting input from a location;
receiving a response comprising one or more documents, wherein the one or more documents are selected based at least in part on the input; and
receiving a legal information communication if the location is determined to be in a legal information communication jurisdiction.

63. A system for receiving legal information communications for documents, comprising:
an output device that transmits input from a location; and
an input device that receives a document in response to the input, wherein the document is selected based at least in part on the input, and for receiving a legal information communication if the location is determined to be in a legal information communication jurisdiction.

64. A method of selectively delivering documents responsive to received information comprising:
receiving a request related to a concept from a requesting system;
identifying one or more documents for possible delivery in response to the request based no the concept; and
determining whether to deliver the one or more documents based at least in part on one or more trademark factors and an acceptance level for trademark usage associated with the requesting system.

65. The method of claim 64 wherein the acceptance level indicates the requesting system's willingness to accept documents associated with trademark-related concepts.

66. The method of claim 64 wherein the documents comprise advertisements.

67. The method of claim 64 further comprising the action of determining whether to include a legal information communication with the document based in part on the acceptance level for trademark usage.

68. The method of claim 64 wherein the determining action is based in part on the location of the requesting system.

69. The method of claim 64 wherein the determining action is based in part on the location of a user to whom the requesting system delivers the document.

70. The method of claim 64 wherein determining action is based in part on a location factor.

71. The method of claim 70 wherein the determining action is based at least in part on a trademark usage level set for the location.

72. The method of claim 71 wherein the determining action uses the more restrictive trademark usage level between the location-based level and the receiving system's acceptance level.

73. A system comprising:
receiving means for receiving a request related to a concept from a requesting system;
identification means for identifying one or more documents for possible delivery in response to the request based no the concept; and
determination means for determining whether to deliver the one or more documents based at least in part on one or more trademark factors and an acceptance level for trademark usage associated with the requesting system.

74. The system of claim 73 wherein the acceptance level indicates the requesting system's willingness to accept documents associated with trademark-related concepts.

75. The system of claim 73 wherein the documents comprise advertisements.

76. The system of claim 73 wherein the determination means determines whether to include a legal information communication with the document based in part on the acceptance level for trademark usage.

77. The system of claim 73 wherein the determination means determines whether to deliver the one or more documents based in part on the location of the requesting system.

78. The system of claim 73 wherein the determination means determines whether to deliver the one or more documents based in part on the location of a user to whom the requesting system delivers the document.

79. The system of claim 73 wherein the determination means determines whether to deliver the one or more documents based in part on a location factor.

80. The system of claim 79 wherein the determination means determines whether to deliver the one or more documents based at least in part on a trademark usage level set for the location.

81. The system of claim 80 wherein the determination means determines whether to deliver the one or more documents based the determining action using the more restrictive trademark usage level between the location-based level and the receiving system's acceptance level.

82. A method of selectively delivering advertisements responsive to received information comprising:
receiving a request related to a concept from a requesting system;
identifying one or more documents for possible delivery in response to the request based no the concept; and
determining whether to deliver the one or more documents depending on whether a trademark usage rating associated with the one or more documents complies with a trademark acceptance level associated with the receiving system.
